(19) United States
(12) Patent Application Publication
(10) Pub. No.: US 2021/0228034 A1
(43) Pub. Date: Jul. 29, 2021

(54) GEARBOX AND INTELLIGENT CLEANING APPARATUS

(71) Applicant: Beijing Roborock Technology Co., Ltd., Beijing (CN)

(72) Inventor: Fan Yang, Beijing (CN)

(73) Assignee: Beijing Roborock Technology Co., Ltd., Beijing (CN)

(21) Appl. No.: 17/232,382

(22) Filed: Apr. 16, 2021

Related U.S. Application Data
(63) Continuation of application No. PCT/CN2019/111765, filed on Oct. 17, 2019.

(30) Foreign Application Priority Data
Oct. 18, 2018 (CN) 201821694664.2

(51) Int. Cl. A47L 9/04; F16H 57/021; A47L 11/24; A47L 11/282; A47L 11/40

(52) U.S. Cl. CPC A47L 9/0433; F16H 57/021; A47L 9/0455; A47L 9/0477; F16H 55/06; A47L 9/0411; A47L 11/24; A47L 11/282; A47L 11/4069; A47L 9/0472

(57) ABSTRACT

The present application provides a gearbox and an intelligent cleaning apparatus. The gearbox is used for the intelligent cleaning apparatus, and includes a rotatable part and a porous bearing. The rotatable part can rotate around a rotation axis to transmit power for a cleaning head of the intelligent cleaning apparatus, and has a contact surface. The porous bearing is fixedly arranged and has a support surface, and the support surface of the porous bearing is in contact with the contact surface of the rotatable part to support the rotatable part in rotating relative to the porous bearing. At least one of the contact surface and the support surface is provided with a recess.

### CROSS-REFERENCE TO RELATED APPLICATIONS

The present application is a continuation application of International Application No. PCT/CN2019/111765, filed on Oct. 17, 2019, which claims priority to Chinese Patent Application No. CN201821694664.2 filed on Oct. 18, 2018, both of which are incorporated herein by reference in their entireties for all purposes.

### TECHNICAL FIELD

The present application relates to the field of cleaning tools, and more specifically, to a gearbox and an intelligent cleaning apparatus.

### BACKGROUND

Generally, most intelligent cleaning apparatuses are equipped with gearboxes to transmit driving power to cleaning assemblies, so that the cleaning assemblies can perform a cleaning task at an appropriate rotation speed.

### SUMMARY

A series of concepts of simplified forms are introduced in the SUMMARY section. These concepts are further described in detail in the DESCRIPTION OF EMBODIMENTS section. The SUMMARY section of the present application does not imply an attempt to define the key features and essential technical features of the claimed technical solutions, nor does it imply an attempt to determine the protection scope of the claimed technical solutions.

An embodiment of the present application provides a gearbox for an intelligent cleaning apparatus, where the gearbox includes:

a rotatable part, configured to rotate around a rotation axis to transmit power for a cleaning head of the intelligent cleaning apparatus; and

a porous bearing fixedly disposed in the gearbox, where a contact surface of the rotatable part and a support surface of the porous bearing contact each other to support rotation of the rotatable part;

where at least one of the contact surface and the support surface is provided with one or more recesses.

According to another aspect provided in embodiments of the present application, an intelligent cleaning apparatus is further provided. The intelligent cleaning apparatus includes a cleaning head and a gearbox. The gearbox includes a rotatable part configured to rotate around a rotation axis to provide power for the cleaning head; and a porous bearing fixedly disposed in the gearbox, where a contact surface of the rotatable part and a support face of the porous bearing contact each other to support rotation of the rotatable part; where at least one of the contact surface and the support surface is provided with one or more recesses.

### BRIEF DESCRIPTION OF DRAWINGS

The following accompanying drawings of embodiments of the present application are used herein as a part of the present application for understanding the present application. The accompanying drawings show the embodiments of the present application and descriptions of the embodiments, which are used to explain principles of the present application. In the drawings:

FIG. 1 is a schematic view of an intelligent cleaning apparatus according to an embodiment of the present application;

FIG. 2 is a schematic view of another perspective of the intelligent cleaning apparatus shown in FIG. 1;

FIG. 3 is an exploded view of a gearbox according to an embodiment of the present application;

FIG. 4 and FIG. 5 are stereoscopic views of an output gear of the gearbox shown in FIG. 3; and

FIG. 6 is a schematic diagram of arranging a recess on a support surface and/or a contact surface.

### DESCRIPTION OF EMBODIMENTS

The following describes numerous specific details to provide a more thorough understanding of the present application. However, it is obvious to a person skilled in the art that the embodiments of the present application can be implemented without one or more of these details. In other examples, to avoid confusion with the embodiments of the present application, some technical features well known in the art are not described.

The following description provides a detailed structure for a thorough understanding of the embodiments of the present application. Clearly, the implementation of the embodiments of the present application is not limited to the specific details well known to a person skilled in the art.

With reference to the accompanying drawings, the following describes a gearbox and an intelligent cleaning apparatus provided according to the embodiments of the present application. It can be understood that the intelligent cleaning apparatus shown in the embodiments of the present application may be a sweeping robot, a mopping robot, a sweeping and mopping robot, or the like. In the embodiments, the intelligent cleaning apparatus may be a cleaning robot integrating the functions of sweeping and mopping.

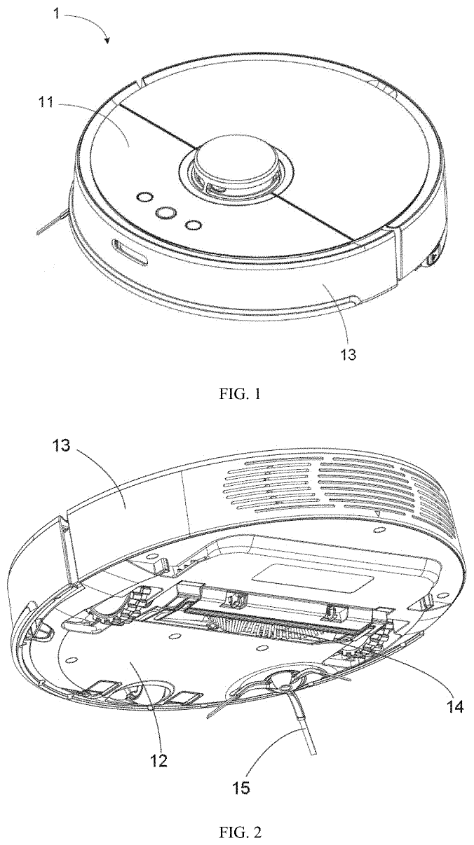

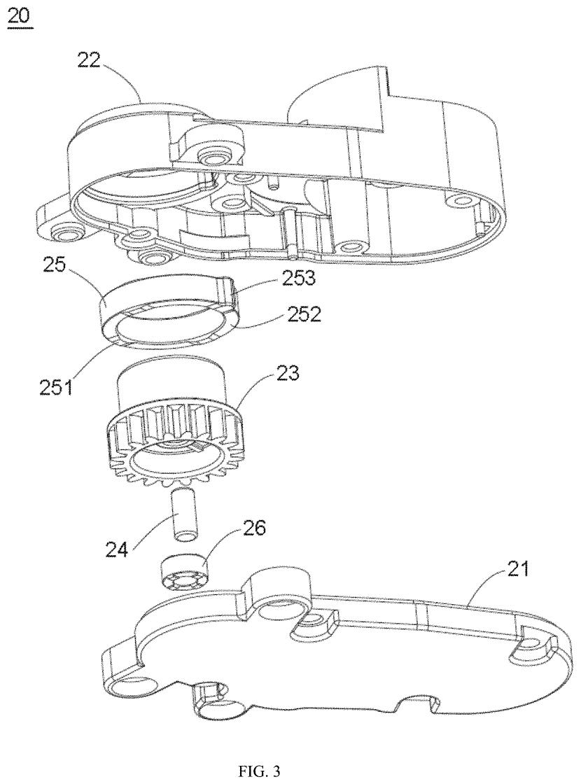

The intelligent cleaning apparatus mainly includes a cleaning system, a perception system, a control system, a driving system, an energy system, a man-machine interaction system, etc. Various systems cooperate with each other to make the intelligent cleaning apparatus autonomously move and implement a cleaning task. FIG. 1 and FIG. 2 are example stereoscopic views of an intelligent cleaning apparatus according to an embodiment of the present application. The intelligent cleaning apparatus mainly includes a device body 1. The elements that constitute the foregoing systems device are mounted in the device body 1.

As shown in FIG. 1 and FIG. 2, the device body 1 has an approximate circular shape (both the front and the back are circular), and includes an upper cover 11, a chassis 12, and a middle frame 13 arranged between the upper cover 11 and the chassis 12. The middle frame 13 serves as a basic frame for arranging various functional elements. The upper cover 11 and the chassis 12 respectively cover an upper surface and a lower surface of the middle frame 13 to protect internal parts and improve appearance of the intelligent cleaning apparatus. Certainly, in other embodiments, the device body 1 may have other shapes, including but not limited to an approximate D-shape, that is, the front is straight and the back is circular.

The driving system is used for providing driving force for the smart cleaning system to autonomously move, and for the cleaning system to implement the cleaning function. The perception system is used for the intelligent cleaning apparatus to perceive an external environment such as topography, and provides various position information and motion state information of the machine for the control system. The control system comprehensively determines a current working status (such as crossing a threshold, crossing the edge of a carpet, reaching a cliff, being stuck, full dust box, or being picked up) of the intelligent cleaning apparatus based on the foregoing information, and provides next actions based on different situations. Furthermore, the control system may plan an efficient and reasonable cleaning route and cleaning mode based on information about an instant map, thereby improving the working efficiency of the intelligent cleaning apparatus. The man-machine interaction system is used by a user to select functions and/or to display the current status of the intelligent cleaning apparatus or function options. The energy system is used for supplying power to the functional elements of the systems.

The cleaning system is an important system of the intelligent cleaning apparatus, and is used for implementing a cleaning task. The cleaning system may include a dry cleaning assembly and a wet cleaning assembly. The dry cleaning assembly is mainly configured to remove specific particulate pollutants from a surface. The wet cleaning assembly is mainly configured to mop a surface (such as a floor surface).

Specifically, the dry cleaning assembly may mainly include a cleaning brush, a waste container, and a vacuum. As shown in FIG. 2, the cleaning brush may include a primary brush 14 and a side brush 15. The primary brush 14 has a rotation shaft substantially parallel to a plane on which the chassis 12 is located and protrudes outward from the chassis 12. As a result, the primary brush 14 interferes with the floor surface under the chassis 12. The side brush 15 is arranged at the edge of the bottom of the device body 1, and its rotation shaft is at a certain angle with respect to the floor surface, so that debris can be moved into the cleaning region of the primary brush 14 while the side brush 15 rotates. The vacuum is connected to the waste container, and the vacuum is configured to generate suction force. When the primary brush 14 rotates with the rotation shaft, the debris on the floor surface is agitated by the primary brush 14 and taken to a suction door between the primary brush 14 and the waste container, and then sucked into the waste container by the suction force generated by the vacuum. The wet cleaning assembly mainly includes a liquid reservoir and a cleaning cloth. The liquid reservoir may be configured to contain cleaning liquid, and the cleaning cloth is detachably disposed on the liquid reservoir. After the dry cleaning assembly completes cleaning, the liquid in the liquid reservoir flows to the cleaning cloth, and the cleaning cloth mops the floor surface cleaned by the dry cleaning assembly.

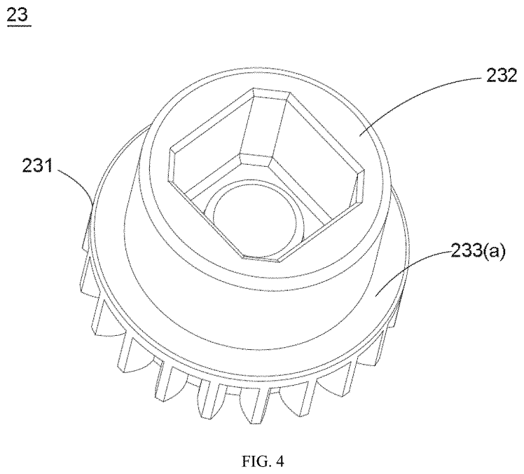

According to an embodiment of the present application, a gearbox 20 shown in FIG. 3 is disposed in the device body 1 of the intelligent cleaning apparatus. The gearbox 20 may connect to a driving motor of the driving system and the cleaning brush of the dry cleaning assembly of the cleaning system, and is configured to transmit the driving force of the driving motor to the cleaning brush, to make the cleaning brush rotate around the rotation shaft.

As shown in FIG. 3, the gearbox 20 includes a first housing 21 and a second housing 22. The first housing 21 and the second housing 22 form an accommodation space for accommodating components of the gearbox 20 and serve as a basic frame for installing these components. The transmission function of the gearbox 20 is implemented by an input gear and an output gear 23. When being installed in the device body 1, the input gear is connected to the driving motor of the driving system, and the output gear 23 is engaged to the rotation shaft of the primary brush 14 or side brush 15. The transmission between the input gear and the output gear is implemented by the gears that engage each other, so that the driving force is transmitted to the primary brush 14 or the side brush 15 at an appropriate rotation speed. For the sake of brevity, the input gear and its mating components are omitted in FIG. 3. The following describes the output gear 23.

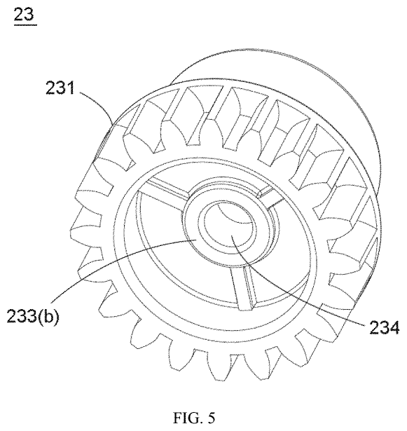

As shown in FIG. 4 and FIG. 5, the output gear 23 may include a gear body 231. The gear body 231 is substantially constructed in a cylindrical shape, and a plurality of teeth for engaging are arranged on a side surface of the gear body 231 at intervals in the circumferential direction. As can be seen in FIG. 4, one end of the gear body 231 in the axial direction is provided with an engaging part 232 protruding outward. The engaging part 232 protrudes outward from the surface of the first housing 21 or the second housing 22 to facilitate engagement with the rotation shaft of the primary brush 14. As shown in FIG. 5, the gear body 231 is recessed inward on the side opposite to the engaging part 232 in the axial direction, and a hole 234 is formed at the center. Referring back to FIG. 3, the gearbox 20 further includes a shaft 24. The shaft 24 is fixedly disposed in the gearbox 20, and the output gear 23 is sleeved on the shaft 24 through the hole 234 and can rotate around the shaft 24. The shaft 24 defines the rotation axis of the output gear 23. To prevent the shaft 24 from interfering with the engagement between the engaging part 232 and the rotating shaft of the primary brush 14, the hole 234 is closed at one end close to the engaging part 232.

The output gear 23 is supported by a porous bearing in the gearbox 20. According to an embodiment of the present application, a first porous bearing 25 and a second porous bearing 26 are respectively disposed on both sides of the output gear 23 in the axial direction. As shown in FIG. 3, the first porous bearing 25 is located at the end of the output gear 23 where the engaging part 232 is disposed. The engaging part 232 protrudes outward through the first porous bearing 25. The second porous bearing 26 is disposed at the end of the output gear 23 opposite to the engaging part 232 in the axial direction, and is accommodated in the recess of the end. Both the first porous bearing 25 and the second porous bearing 26 are disposed coaxially with the output gear 23.

The first porous bearing 25 and the second porous bearing 26 may have similar structures and differ from each other in size. For this reason, only the first porous bearing 25 is described herein. It can be understood that the structural features of the first porous bearing 25 may be also applicable to the second porous bearing 26.

The first porous bearing 25 is constructed in a circular ring shape, and is provided with at least one radially outward protrusion 253 on the side surface. The first porous bearing 25 is fixed by cooperation with a groove on the first housing 21 and the protrusion 253, or a groove on the second housing 22 and the protrusion 253. The first porous bearing 25 has a support surface 251 that supports the rotation of the output gear 23. Correspondingly, as shown in FIG. 4 and FIG. 5, the output gear 23 has a contact surface 233 that contacts the support surface 251. In an embodiment of the present application, the surface of the output gear 23 that contacts the first porous bearing 25 may be referred to as a contact surface 233(a), and the surface of the output gear 23 that contacts the second porous bearing 26 may be referred to as a contact surface 233(b).

In an existing gearbox, the relative rotation between the porous bearing and the output gear will cause a loud noise and a temperature increase. To solve this problem, as shown in FIG. 3, according to an embodiment of the present application, the support surface 251 of the first porous bearing 25 is provided with a recess 252. Thus, in the case that the first porous bearing 25 supports the output gear 23, the contact surface 233(a) does not contact the recess 252 of the first porous bearing 25. In this way, the contact area between the support surface 251 and the contact surface 233(a) reduces, that is, the area in which friction is generated reduces, thereby effectively reducing the noise and temperature increase caused by friction.

A plurality of recesses 252 may be provided to further reduce the contact area. However, it should be noted that the plurality of recesses 252 should be evenly distributed around the rotation axis to ensure a stable support and avoid deflection during the rotation. In addition, the output gear 23 may alternatively be made of plastic material, thereby further reducing the noise and temperature increase caused by friction.

In the illustrated embodiment, the recess 252 is provided on the support surface 251 of the first porous bearing 25. It can be understood that, in other embodiments, the recess 252 may be provided on the contact surface 233(a) of the output gear 23, or the recess 252 may be provided on both the contact surface 233(a) and the support surface 251.

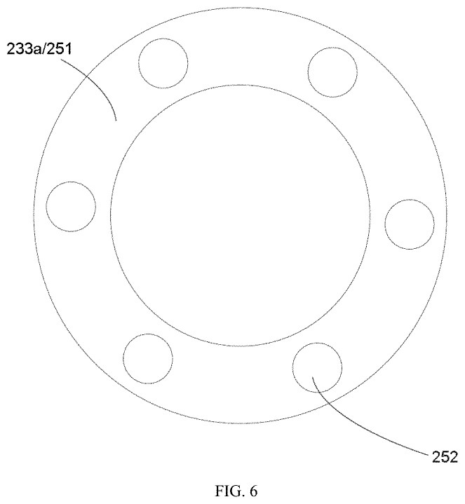

It should be noted that, in the illustrated embodiment, four recesses 252 divide the support surface 251 of the first porous bearing 25 into four discontinuous portions. Therefore, if recesses are also provided on the contact surface 233(a), the area of the recesses on the contact surface 233(a) corresponding to the support surface 251 (that is, the recesses that can be aligned with the support surface 251 during rotation) is smaller than the area of each support surface 251, or projections of each support surface 251 and the recess on a plane perpendicular to the rotation axis do not overlap, so as to prevent the support surface 251 from falling into the recess when the support surface 251 rotates to a position aligned with the recess, which causes unstable support. Alternatively, the recesses 252 on both the contact surface 233(a) and the support surface 251 can be provided in the form shown in FIG. 6, that is, the contact surface 233(a) or the support surface 251 is still a continuous surface after being provided with the recess 252, instead of being divided into several independent portions by the recess.

In addition, it can be understood that the foregoing structure in which the output gear and the porous bearing cooperate with each other is also applicable to the input gear of the gearbox.

The gearbox and the intelligent cleaning apparatus according to the embodiments of the present application have been described above. According to the gearbox provided in the embodiments of the present application, at least one of the contact surface and the support surface that are in contact and move relative to each other is provided with a recess, so that a surface area of the contact surface and the support surface in contact with each other reduces, thereby effectively reducing noise and temperature increase caused by the relative rotation of the rotatable part and the porous bearing.

Unless otherwise defined, the technical and scientific terms used in this specification have the same meanings as those commonly understood by a person skilled in the art of the present application. The terms used in this specification are merely for the purpose of describing specific implementation, and are not intended to limit the present application. Terms such as “dispose” that appear in this specification may indicate that one part is attached directly to another part, or may indicate that one part is attached to another part by using an intermediate part. In this specification, a feature described in one embodiment can be applied to another embodiment individually or in combination with other features, unless the feature is not applicable or otherwise stated in another embodiment.

The present application has been described by using the foregoing embodiments, but it should be understood that the foregoing embodiments are used only for the purposes of illustration and description, and are not intended to limit the present application to the scope of the described embodiments. A person skilled in the art can understand that further variations and modifications can be made according to the teachings of the present application. These variations and modifications fall within the protection scope of the present application.

What is claimed is:

1. A gearbox for an intelligent cleaning apparatus, comprising:
a rotatable part, configured to rotate around a rotation axis to provide power for a cleaning head of the intelligent cleaning apparatus; and
a porous bearing fixedly disposed in the gearbox, wherein a contact surface of the rotatable part and a support surface of the porous bearing contact each other to support rotation of the rotatable part;
wherein at least one of the contact surface and the support surface is provided with one or more recesses.

2. The gearbox according to claim 1, wherein the one or more recesses are provided on the support surface.

3. The gearbox according to claim 2, wherein there are a plurality of the recesses, which are evenly distributed around the rotation axis.

4. The gearbox according to claim 1, wherein the one or more recesses are provided on the contact surface.

5. The gearbox according to claim 4, wherein there are a plurality of the recesses, which are evenly distributed around the rotation axis.

6. The gearbox according to claim 1, wherein the rotatable part is an output gear, which provides the power for the cleaning head of the intelligent cleaning apparatus by engaging an input gear connected to a motor.

7. The gearbox according to claim 6, wherein the output gear engages a rotation shaft of the cleaning head by an engaging part protruding outward at an end of the output gear along the rotation axis.

8. The gearbox according to claim 6, wherein the porous bearing supports the output gear at an end of the output gear along the rotation axis.

9. The gearbox according to claim 6, wherein the output gear is made of plastic material.

10. The gearbox according to claim 6, wherein the porous bearing comprises:
a first porous bearing, disposed at a first end of the output gear along the rotation axis; and
a second porous bearing, disposed at a second end opposite to the first end of the output gear along the rotation axis.

11. The gearbox according to claim 1, wherein the support surface and the contact surface are both perpendicular to the rotation axis.

12. The gearbox according to claim 1, wherein:
the one or more recesses comprises one or more first recesses provided on the support surface and one or more second recesses provided on the contact surface,
each of the one or more first recesses is positioned such that remaining portions separated by the one or more first recesses of the support surface are all prevented from falling into any of the one or more second recesses as the rotatable part rotates around the rotation axis, and
each of the one or more second recesses is positioned such that remaining portions separated by the one or more second recesses of the contact surface are all prevented from falling into any of the one or more first recesses as the rotatable part rotates about the rotation axis.

13. The gearbox according to claim 1, wherein the at least one of the contact surface and the support surface provided with the one or more recesses is a continuous surface.

14. An intelligent cleaning apparatus, comprising:
a cleaning head; and
a gearbox comprising:
a rotatable part configured to rotate around a rotation axis to provide power for the cleaning head; and
a porous bearing fixedly disposed in the gearbox, wherein a contact surface of the rotatable part and a support surface of the porous bearing contact each other to support rotation of the rotatable part;
wherein at least one of the contact surface and the support surface is provided with one or more recesses.

15. The intelligent cleaning apparatus according to claim 11, wherein the cleaning head is configured to rotate around a rotation shaft generally parallel to a floor surface to brush the floor surface as the intelligent cleaning apparatus is propelled across the floor surface.

16. The intelligent cleaning apparatus according to claim 15, wherein the rotatable part is an output gear, which provides the power for the cleaning head by engaging an input gear connected to a motor.

17. The intelligent cleaning apparatus according to claim 16, wherein the output gear engages a rotation shaft of the cleaning head by an engaging part protruding outward at an end of the output gear along the rotation axis.

18. The intelligent cleaning apparatus according to claim 14, wherein the cleaning head extends beyond a housing perimeter of the intelligent cleaning apparatus, and is configured to rotate about a rotation shaft generally perpendicular to a floor surface to remove debris beyond the housing perimeter.

19. The intelligent cleaning apparatus according to claim 18, wherein the rotatable part is an output gear, which provides the power for the cleaning head by engaging an input gear connected to a motor.

20. The intelligent cleaning apparatus according to claim 19, wherein the output gear engages a rotation shaft of the cleaning head by an engaging part protruding outward at an end of the output gear along the rotation axis.
